(19) United States
(12) Patent Application Publication
(10) Pub. No.: US 2007/0236577 A1
(43) Pub. Date: Oct. 11, 2007

(54) Systems and methods for providing image stabilization

(76) Inventors: Chau-Yaun Ke, Pintung County (CN); Yu-Chien Huang, Taipei (CN)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/392,732

(22) Filed: Mar. 30, 2006

(51) Int. Cl. H04N 5/228

(52) U.S. Cl. 348/208.99

(57) ABSTRACT

A system and method provides image stabilization in an image capture device. In one embodiment, a system includes a stationary base included in an image capture device. The system may also include a movable base positioned on top of the stationary base. A point contactor including a set of ball bearings is configured to be either connected to the stationary base such that the set of ball bearings contact a supporting module connected to the movable base such that the movable base moves in relation to the stationary base, or connected to the movable base such that the set of ball bearings contact a supporting module connected to the stationary base such that the movable base moves in relation to the stationary base.

### TECHNICAL FIELD

This disclosure relates generally to image capture operations, and more particularly, to systems and methods for stabilizing images in image capture devices.

### BACKGROUND

Image capture devices, such as digital cameras, have grown in popularity. As a result, advances in technology supporting features associated with these devices also continues to move forward. For example, image stabilization technology, or anti-shake technology, has been developed to improve the performance of image capturing mechanisms used in digital cameras. This technology provides components that minimize the effects of user-induced movements of a camera during image capture, such as blurring.

Generally, conventional systems use three methods to reduce blurring in image capture devices. Anti-shake technology may be implemented that moves the lens of the camera to more appropriately align light into an image capture component, such as a CMOS or CCD sensor. Alternatively, the technology may control the angle of light emitted into the CCD or CMOS sensors. Further, the anti-shake technology may be configured to move the CCD or sensor to properly align with the lens.

Conventional systems use different types of mechanisms to implement these methodologies. For instance, U.S. Pat. No. 5,463,443 discloses an anti-shake system that uses screw mechanisms and directional actuators to move the lens into position of a camera's sensors. The system uses an angular sensor system that provides angular velocity data to a control circuit that determines a movement amount in a particular direction (i.e., X or Y-axis direction). Based on the movement amount, the system generates a drive signal for a correction lens component including a motor and feed screw associated with the movement amount direction. The system drives the motor to move the lens of the camera via the feed screw(s) to correct for camera shake. Similarly, U.S. Pat. No. 5,416,558 discloses an anti-shake system for a camera that moves the lens components for correcting camera shake. The '558 patent discloses use of guide rods and a DC motor to drive actuators for moving lens components to reduce blurring caused by camera shake.

Although conventional anti-shake systems provide mechanisms for reducing the effects of camera movements during image capture, these systems have some drawbacks. For example, the configuration of conventional anti-shake systems, such as those implementing motor driven actuators, increase the size of the system, thus limiting their applications in smaller sized camera systems, such as those implemented in mobile telephones. Further, the power required to drive components along a screw, rod, or mounting plate may be unnecessarily high due to the friction produced by components that adjust the lens, such as screw or rod mechanisms.

Systems and methods consistent with certain embodiments of the present invention correct these and other problems in anti-shake for image capture devices.

### SUMMARY OF THE INVENTION

In one embodiment, a system is disclosed for providing image stabilization in an image capture device. In one embodiment, the system may include a stationary base included in an image capture device. The system may also include a movable base positioned on top of the stationary base. A point contactor including a set of ball bearings is configured to be either connected to the stationary base such that the set of ball bearings contact a supporting module connected to the movable base such that the movable base moves in relation to the stationary base, or connected to the movable base such that the set of ball bearings contact a supporting module connected to the stationary base such that the movable base moves in relation to the stationary base.

In another embodiment, a method is disclosed for performing image stabilization in an image capture device. The method may include providing a first amount of current in a first direction on a link connected to a pair of coils positioned on a movable base that is positioned above a stationary base including a pair of magnets. The movable base may be positioned such that each coil of the pair of coils is positioned above a corresponding magnet of the pair of magnets. The method may also include moving the movable base in a first direction, in relation to the stationary base, based on the first amount and first direction of current on the link. The movement of the movable base causes a set of ball bearings included in a point contactor connected to the stationary base to roll against a supporting module connected to the movable base.

In another embodiment, a system is disclosed including a first means including a set of magnets and included in the image capture device. The system includes a second means positioned on top of the first means such that the second means moves in relation to the first means to compensate for a movement of the image capture device. Further, the system may include a third means connected to the first means and including friction reducing means that contact a supporting module connected to the second means.

In another embodiment, a method for performing image stabilization in an image capture device is disclosed. The method may include providing a first amount of current in a first direction on a link connected to a pair of coils positioned on a stationary base that is positioned below a movable base including a pair of magnets. The stationary base positioned such that each coil of the pair of coils is positioned below a corresponding magnet of the pair of magnets further, the method includes moving the movable base in a first direction, in relation to the stationary base, based on the first amount and first direction of current on the link such that the movement of the movable base causes a set of ball bearings of a point contactor to roll against a supporting module.

### BRIEF DESCRIPTION OF THE DRAWINGS

In the drawings:

FIG. 1 is a block diagram of an exemplary image capture system consistent with certain disclosed embodiments;

FIG. 2 is a diagram of an exemplary image stabilizer consistent with certain disclosed embodiments;

FIG. 3 is a diagram of an exemplary stationary base showing a point contactor consistent with certain disclosed embodiments;

FIG. 4 is a block diagram illustrating an exemplary construction of the image stabilizer shown in FIG. 2 consistent with certain disclosed embodiments;

FIG. 5 is an exploded view illustrating another exemplary construction of the image stabilizer shown in FIG. 2 consistent with certain disclosed embodiments;

FIG. 6 is a diagram of an exemplary ferromagnetic material arrangement consistent with certain disclosed embodiments;

FIG. 7 is a diagram of an exemplary voice coil motor arrangement consistent with certain disclosed embodiments;

FIG. 8 is a diagram of another exemplary image stabilizer consistent with certain disclosed embodiments;

FIG. 9 is a diagram illustrating an exemplary construction of the image stabilizer shown in FIG. 8 consistent with certain disclosed embodiments;

FIG. 10 is a diagram of exemplary image stabilization and auto-focusing combination consistent with certain disclosed embodiments;

FIG. 11 is a flow chart of an exemplary position adjustment process for a movable base consistent with certain disclosed embodiments; and

FIG. 12 is a flow chart of an exemplary position determination process consistent with certain disclosed embodiments.

### DETAILED DESCRIPTION

Reference will now be made in detail to exemplary embodiments and illustrations. Wherever possible, the same reference numbers will be used throughout the drawings to refer to the same or like parts. While specific configurations and arrangements are discussed, it should be understood that this is done for illustrative purposes only.

Methods and systems consistent with the disclosed embodiments provide image stabilization for image capture devices. In one embodiment, an image stabilization system is configured to reduce friction between a lens supporting module connected to a movable base and a stationary base. For example, the system may implement a voice control motor system that adjusts the position of the movable base in relation to a stationary base using a thrust ball bearing component. This component includes ball bearings that enable the movable base to move along a directional axis in relation to the stationary base with less friction than that produced in conventional anti-shake technologies. As a result, less power is required to perform image stabilization operations as compared to anti-shake technologies associated with conventional systems. The design and material of the ball bearings may be such as to minimize errors in the stabilization system, such as that resulting from tilting of the lens support component during image capture. Further, the configuration of the image stabilization system may be adjusted to reduce the thickness of the system for applications in devices not available for conventional anti-shake technologies, such as mobile phone image capture systems. Additionally, the reduced thickness of the reconfigured image stabilization system allows the system to be implemented with an auto-focusing module of an image capture system. Thus, disclosed embodiments describe an integrated image stabilization and auto-focusing system.

In other embodiments, the disclosed image stabilization system may include upper ferromagnetic material positioned next to electromagnetic coils located on the movable base and lower ferromagnetic material positioned next to magnets positioned on the stationary base to control direction of magnetic energy produced by the magnets during image stabilization operations. In another embodiment, the image stabilization system may implement a Hall sensor system that is configured to determine and provide positional information of the movable base in relation to the stationary base. In certain embodiments, the Hall sensor system may provide the positional information to external components for processing.

Additional features and functions of the disclosed embodiments are described below. It should be noted, however, that the examples described herein are not intended to be limiting to the present invention.

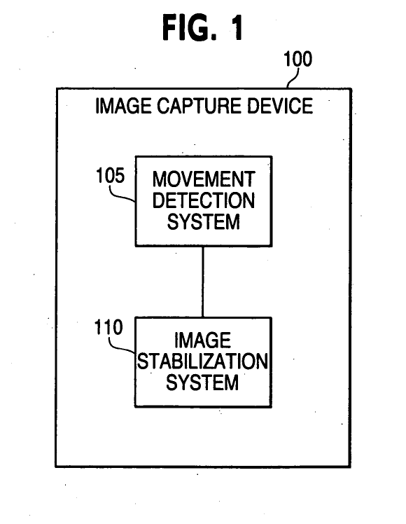

FIG. 1 shows a block diagram of an exemplary image capture system consistent with certain embodiments of the present invention. As shown in FIG. 1, an image capture device 100 is provided that may be any type of device that includes components (e.g., software, hardware, and/or firmware) for capturing one or more images. For example, image capture system 100 may be a system specifically designed for capturing images, such as a digital camera. Alternatively, image capture system 100 may reflect other types of devices, such as systems that include image capture components (e.g., a mobile phone including digital camera components). In certain operations, a user may use image capture device 100 to capture images. During such use, the user may inadvertently shake device 100, which may result in image blurring. It should be noted that the above examples are not intended to be limiting, as methods and systems consistent with the disclosed embodiments may be implemented with any type of image capture device or system that is used by a machine or a user. For example, image capture device 100 may be an image device that is mounted to machinery that automatically captures images. The machinery may vibrate causing blurring. Accordingly, methods and systems consistent with the disclosed embodiments may be implemented to correct for the vibrations.

Image capture device 100 may include components (e.g., hardware, software, and firmware) for performing image capturing operations. For example, image capture device 100 may include one or more lenses, sensors, actuators, processors, circuitry, memory, software, etc. (not shown) that enable device 100 to operate as any type of image capture device. In one embodiment, image capture device 100 may include image stabilization components for performing anti-shake functions during image capture operations. For example, image capture device 100 may include a movement detection system 105 and an image stabilization system 110. Movement detection system 105 may be one or more components configured to detect, collect, and process information associated with the movement of image capture device 100. For example, movement detection system 105 may include one or more sensors for detecting velocity, acceleration, vibration, or other movement-related information associated with image capture device. Detection system 105 may process the movement information, along with other types of image capture data, and provides the processed data to image stabilization system 110.

Image stabilization system 110 may be a system configured to perform anti-shake functions to reduce image blurring caused by movements of image capture device 100 as detected by detection system 105. In one embodiment, image stabilization system 110 may include hardware, software, and/or firmware related to anti-shake technologies, such as circuitry, processors, and/or controllers that process data, instructions and/or provide current, voltage, commands, signals, etc. for controlling, driving, directing, adjusting, etc. components of image stabilizations system 110.

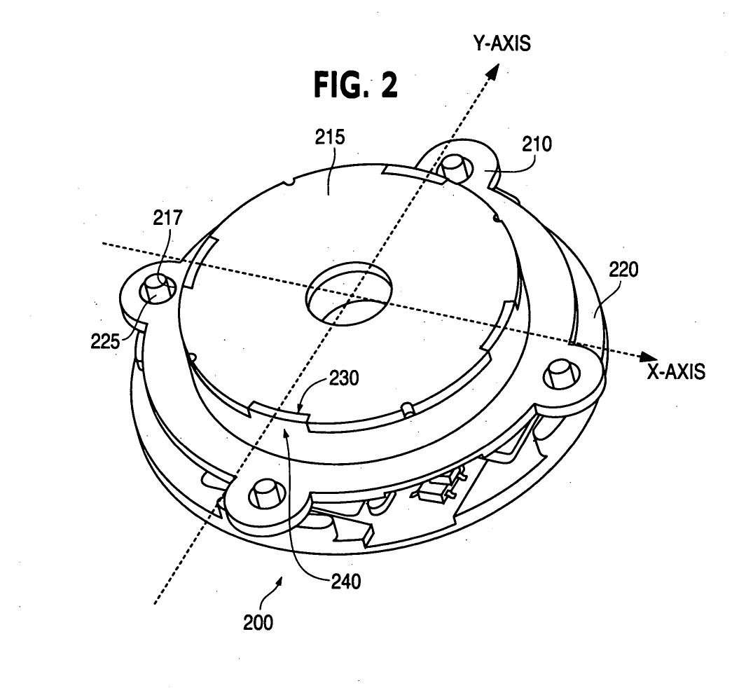

FIG. 2 shows a diagram of an exemplary image stabilizer 200 consistent with certain embodiments of the present invention. Image stabilizer 200 may be a system implemented within image stabilization system 110 to provide anti-shake operations in accordance with the disclosed embodiments. As shown, image stabilizer 200 may include a movable base 210 and a stationary base 220. In accordance with certain embodiments, image stabilizer 200 may be configured such that movable base 210 may be controlled to move along X and Y-directional axes in relation to stationary base 220, as shown in FIG. 2. The orientation of the X and Y-axes depicted in FIG. 2 is not intended to be limiting. That is, the direction of an X-axis and/or a Y-axis in relation to movable base 210 and stationary base 220 may vary. By configuring a lens supporting module 215 for supporting lens components on the movable base 210, image stabilizer 200 may adjust the position of the lens components in relation to the stationary base 220 for performing anti-shake operations. It should be noted that the term “lens supporting module” is not intended to be limiting to the invention. Supporting module 215 may support other types of components instead of, or in addition to, lens components. Stationary base 220 may include pegs 225 that protrude upward from the stationary base 220. Movable base 210 may be seated on pegs 225 via holes 217, which may be designed to have a diameter larger than the diameter of each peg 225. Based on the difference in sizes, movable base 210 is able to freely move along the X and Y-axes within range of the size of the gap between the diameter of peg 225 and hole 217.

In one embodiment, image stabilizer 200 performs anti-shake operations using a voice coil motor, which uses electromagnetic attraction and repulsion to control movement of movable base 210 and lens supporting module 215. The voice coil motor may implement several metal coils, each wrapped around a respective metal structure and mounted on the underside of movable base 210. In one embodiment, the coil structure may be rectangular in shape, although any type of shape having a closed loop or open loop, may be implemented. Stationary base 220 may also include a bipole magnet for each coil mounted on movable structure 210. Each magnet is mounted such that when movable base 210 is positioned on stationary base 220, a coil and corresponding magnet are spatially aligned with each other (i.e., positioned adjacent each other). When current is fed to the each coil, an electromagnetic field is generated that causes a force to be produced in a perpendicular direction to the direction of the current fed in the coil. In one embodiment, the amount of perpendicular force may be determined according to the relationship, F=I L×B, where I is the amount of current applied to a wire coil of length L, and B is the magnetic flux of the magnetic field provided by the magnet used in the voice coil motor. By controlling the current, the image stabilizer 200 may control the movement of movable base 210 in relation to fixed base 220. By affixing component(s) to the movable base, or parts thereof, embodiments of the presenting invention may control the movement of these components, such as a lens component mounted on lens supporting structure 215.

It should be noted that the position of the coils and corresponding magnets implemented by embodiments of the present invention may be interchanged. For example, the magnets may be located on movable base 210 and the coils located on stationary base 220.

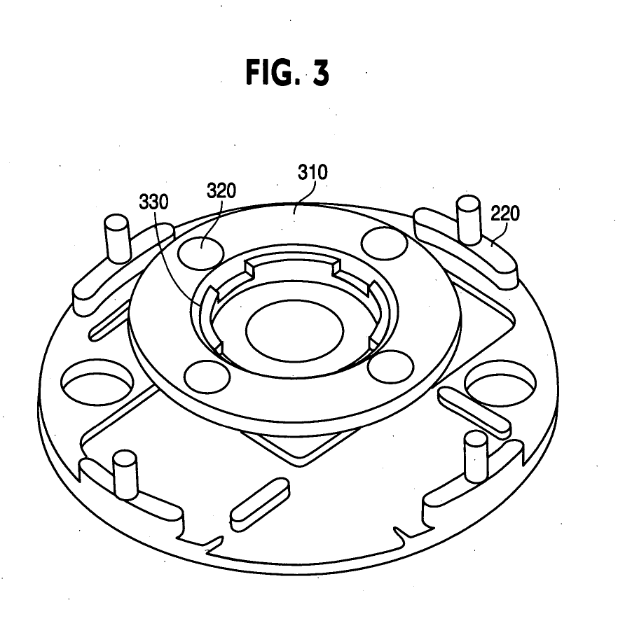

In one embodiment, image stabilizer 200 may use friction reducing means, such as a point contactor, for moving movable base 210 to provide image stabilization functions. Friction reducing means may be a component that has a configuration and/or includes material that reduces the amount of friction produced during movement of movable base 210 on stationary base 220. For example, FIG. 3 shows a diagram of an exemplary point contactor 310 implemented with stationary base 220 consistent with certain embodiments of the present invention. Point contactor 310 may be a component that is configured to reduce the friction associated with mechanisms used for moving elements used in anti-shaking mechanisms consistent with embodiments of the present invention.

In one embodiment, point contactor 310 may be a thrust ball bearing component including one or more ball bearings 320 that roll against supporting module connected to movable base 210. Although FIG. 3 shows point contactor 310 including four ball bearings 320, embodiments of the present invention are not limited to such a configuration. For example, in a preferred embodiment, point contactor 310 may be a thrust ball bearing component having three or more ball bearings 320. Further, point contactor 310 may be configured with any type of material, such as metal, plastics, rubber, ceramic etc. Additionally, each ball bearing 320 may be configured with any type of material, such as metal, plastic, polymers, rubber, ceramics, etc. In one embodiment, ceramic material may be used to reduce the affect ball bearings 320 may have on the magnetic fields associated with, for example, voice coil motor operation. Additionally, the shape of point contactor 310 is not intended to be limiting. Embodiments of the present invention may implement a point contactor 310 having any type of shape, such as a square, rectangular, triangular, trapezoidal, and other types of shapes that may support ball bearings 320.

In certain embodiments, each ball bearing 320 may be configured to certain specifications to reduce tilting of point contactor 310 and/or lens supporting module 215. For example, each ball bearing 320 may be manufactured within a certain degree of tolerance of each other, thus maintaining an even, or relatively even plane between contact of each ball bearing 320 and lens supporting module 215. In certain embodiments, the tolerance of each ball bearing may be determined in proportion to the amount of allowable tilt angle to be experienced by point contactor 310 and/or lens supporting module 215. Thus, ball bearings 320 may be manufactured and configured according to the specified tolerance that is defined in relation to determined specifications associated with tilting of components in image stabilizer 200.

According to certain embodiments, point contactor 310 may be connected to stationary base 220 via a protruding connector module 330. Movable base 210 may be positioned on top of stationary base 220 such that it may travel in axial directions along point contactor 310 via ball bearings 320 and lens supporting module 215.

It should be noted that the configurations of the image stabilizer shown in FIGS. 2, 3, and any subsequent figures, are not intended to be limiting. Different configurations (e.g., size, shape, materials, etc.) may be used to implement the features disclosed by the embodiments of the present invention.

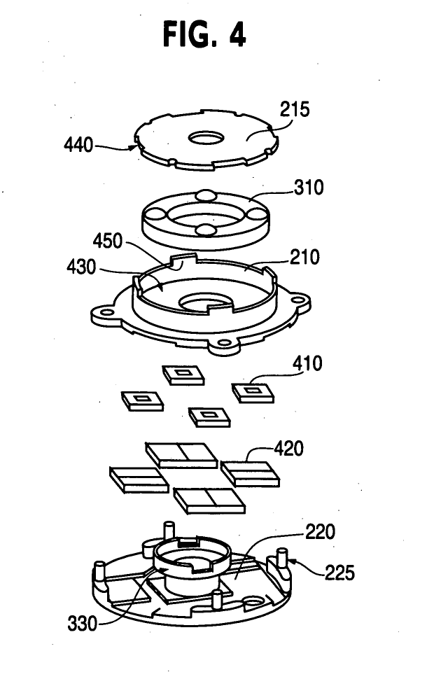

FIG. 4 shows a diagram of an exploded view of certain components of image stabilizer 200. As shown, image stabilizer 200 may include stationary base 220 that supports magnets 420. Movable base 210 may include coils 410 on its underside such that when movable base 210 is positioned on top of stationary base via connector module 330 and pegs 225, each coil 410 matches with a corresponding magnet 420 and thus, is positioned above each respective magnet. Point contactor 310 may be positioned in a recessed portion 430 of movable base 210 and further connects to connector module 330 that protrudes from the stationary base 220 through a center hole of movable base 210. Lens supporting module 215 may be positioned on top of recessed portion 430 of movable base 210 via notches 440 and tabs 450 on each supporting module 217 and movable base 210, respectively. These elements are also shown in FIG. 2, labeled as notches 230 and tabs 240, respectively. Thus, in certain embodiments, when movable base 210 moves in relation to stationary base 220 in response to operation of the voice coil motor arrangement implemented by coils 410 and magnets 420, lens supporting module 215 travels along the plane extended from the ball bearings protruding from the upper plane of point contactor 310.

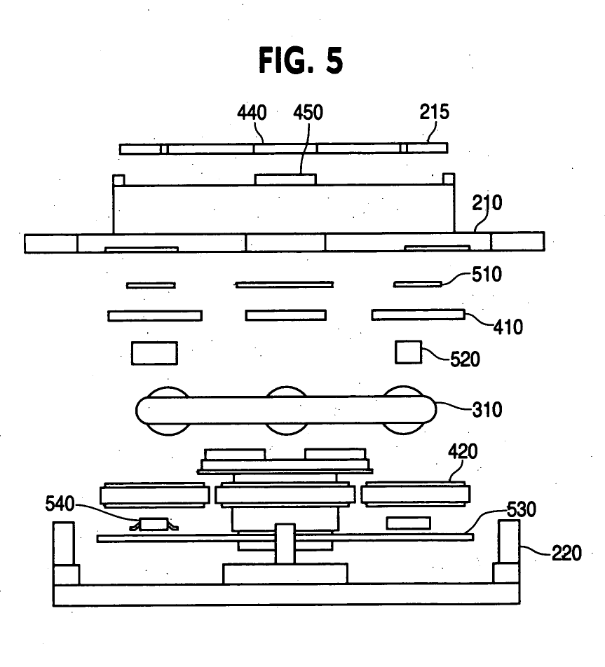

FIG. 5 shows a diagram of an exemplary exploded side view of image stabilizer 200. As shown, lens supporting module 215 fits on top of recessed portion 430 of movable base 210 via notches 440 and tabs 450. As explained above, coils 410 may be positioned on the underside of movable base 210. In one embodiment, an upper ferromagnetic material 510 may be positioned between each coil 410 and movable base 210. Further, a lower ferromagnetic material 530 may be positioned between each magnet 420 and stationary base 220. Accordingly, when movable base 210 is positioned on top of stationary base 220, the configurations with the upper and lower ferromagnetic materials 510 and 530 provide a mechanism for directing the magnetic flux produced by magnets 420 during operation of the voice coil motor arrangement.

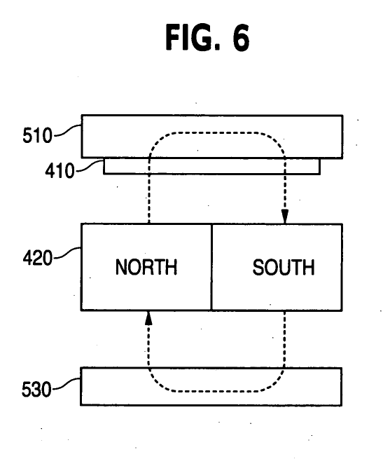

FIG. 6 shows a diagram of an exemplary voice coil arrangement consistent with these embodiments of the present invention. As shown, an upper ferromagnetic material 510 is positioned between coil 410 and movable base 210 and lower ferromagnetic material 530 is positioned between magnet 420 and stationary base 220. This configuration efficiently directs magnetic flux produced between the two poles of magnet 420. Without the ferromagnetic materials, more magnetic flux extending from one pole of magnet 420 is lost in directional space pointing away from the opposite pole of magnet 430 during operation of the voice coil arrangement. In certain embodiments, however, placement of the upper and lower ferromagnetic materials 510 and 530 as described above, directs more magnetic flux toward the opposite pole of magnet 420, thus increasing the amount of perpendicular force produced by the voice coil motor arrangement under similar current requirements. As a result, less current and power is required to drive the voice coil motor to produce movement of movable base 210.

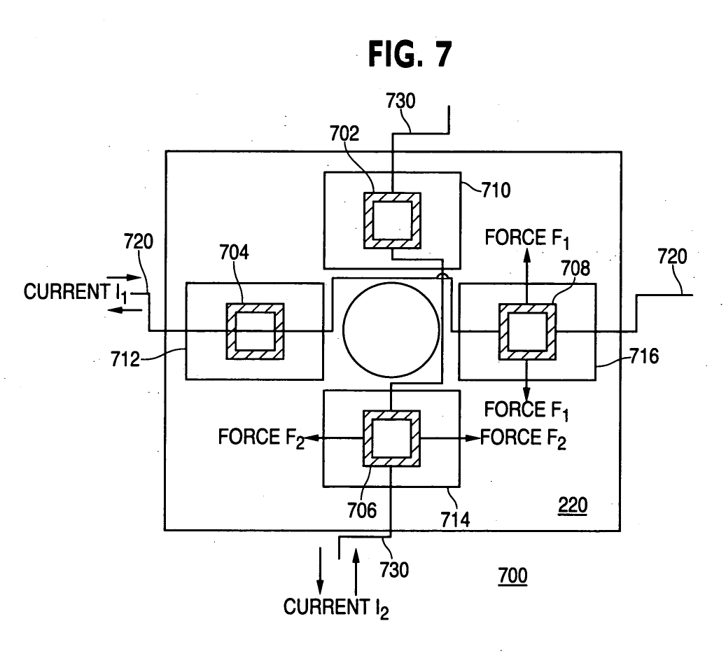

As explained, image stabilizer 200 may be configured with a voice coil motor. FIG. 7 shows a block diagram of an exemplary voice coil motor arrangement 700 for controlling the movement of movable base 210 consistent with certain embodiments of the present invention. As shown, a number of magnets 710, 712, 714, and 716 are located on stationary base 220. Each magnet 710-716 may correspond to corresponding magnets described above. From a top view perspective, FIG. 7 shows coils 702, 704, 706, and 708 positioned above a respective magnets 710, 712, 714, and 716. Coils 702-708 may be located on movable base 210 (not shown) and positioned above magnets 710-716 when movable base 210 is positioned above stationary base 220. Additionally, voice coil arrangement 700 includes links 720 and 730 that connect to corresponding pairs of coils 702-708. For example, link 720 connects to coils 704 and 708 and link 730 connects to coils 702 and 706. Links 720 and 730 may be any type of conductive wire, link, etc. that allows current and voltage to flow, such as copper wire.

In accordance with certain aspects of the present invention, a current I is applied to a respective link 720, 730 by a control system (or similar current source system not shown) in a particular direction (shown as arrows in FIG. 7). Based on the amount of current I and its direction in the link, a perpendicular force F is produced that extends from coils 702-708. The amount and direction of force F produced by a coil depends on the amount and direction of current I flowing in a respective link 720 and 730. For instance, current I₁ may be applied in a first direction of link 720 (shown by the arrows in FIG. 7). Based on the direction and amount of current I₁, a force F1 is produced that extends perpendicular to coils 704 and 708 having a certain amount and direction based on I₁. Similarly, when current I₂ having a certain direction and amount is provided on link 730, a corresponding force F2 is produced that extends perpendicularly from coils 702 and 706 in a certain direction and force. In this arrangement, image stabilizer 200 may control the amount of movement of movable base 210 based on current signals provided on links 720 and 730. In one embodiment, remote components, such as movement detection system 105, may provide current signals I₁ and I₂ to image stabilizer 200. Alternatively, image stabilization system 110 may include components that generate current signals I₁ and I₂ based on signals and/or data from remote components, such as movement detection system 105.

As explained, embodiments of the present invention provide a system that uses a point contactor with ball bearings to reduce friction between lens supporting module 215 and point contactor 220. By reducing the friction, embodiments of the present invention reduce the amount of current I₁ and I₂ used to move movable base 210 of mass M when compared to a configuration using moving parts, such as screw, rod, etc. mechanisms. For example, a movable base of 0.13 grams may be successfully moved for image stabilization processes using a current of 60 mA on links 720 and 730. These values, however, are not intended to be limiting, as the type of material of ball bearings 320, point contactor 310, the dimensions of the components of image stabilizer 200, etc. may affect the amount of current needed to move movable base 210.

In another embodiment, image stabilizer 200 may be configured such that its thickness is minimized. By making image stabilizer 200 thinner, it may be implemented in components that are smaller. For example, image stabilizer 200 described above may be configured for use in a digital camera. A thinner embodiment of image stabilizer 200, however, may be configured to fit inside systems with smaller dimensions, such as a mobile phone, or similar device, that includes image capture components and capabilities.

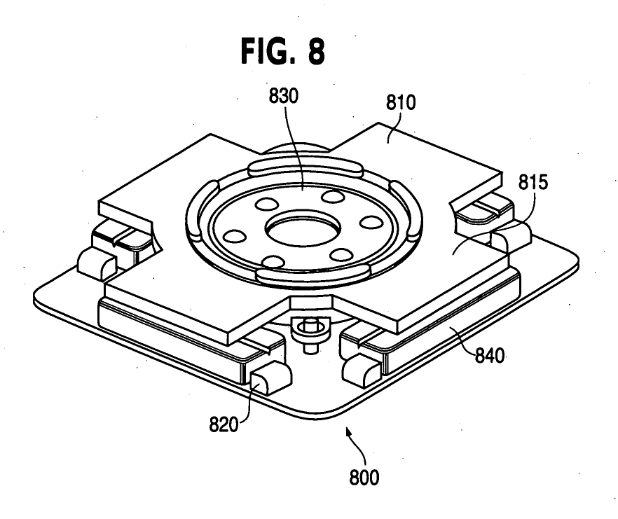

FIG. 8 shows a diagram of an exemplary image stabilizer 800 consistent with these embodiments. Image stabilizer 800 may include the same components and operate in a similar manner as the embodiments of image stabilizer 200 disclosed above. Thus, the components associated with image stabilizer 800 have similar functionality and characteristics as their counterpart components described above in connection with the embodiments of image stabilizer 200. As shown, image stabilizer 800 includes a movable base 810, a stationary base 820, a point contactor 830, and magnets 840. Similar to image stabilizer 200, image stabilizer 800 is configured to move movable base 810 via a voice coil motor arrangement. Thus, although other components of image stabilizer 800 are not shown, such components, such as coils, links, lens support mechanism, Hall sensors, ferromagnetic material, etc., are included in the embodiments associated with image stabilizer 800.

In one embodiment, image stabilizer 800 includes coil support modules 815 that each supports a corresponding coil (not shown) positioned underneath movable base 810. Thus, each coil support module 815 supports a coil such that it aligns with a corresponding one of magnets 840 positioned on stationary base 820. In this arrangement, the magnet/coil pairs are positioned outside of the space below and above of the point contactor 830 and lens supporting module (not shown), which is attached to movable base 810 such that it contacts the ball bearings within point contactor 830. Although image stabilizer 800 is shown with four coil support modules in a square-like manner, embodiments of the present invention are not limited to this configuration.

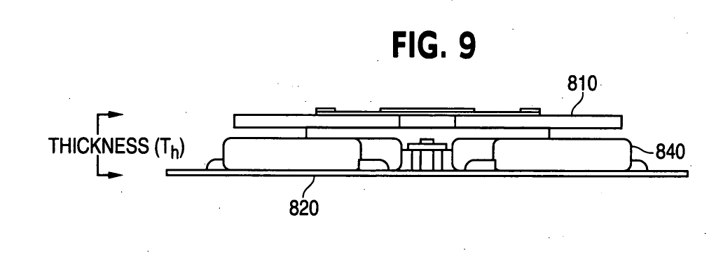

FIG. 9 shows a side view of image stabilizer 800 consistent with certain embodiments of the present invention. As shown, image stabilizer 800 has a thickness Tₕ that, in certain embodiments, may be smaller than that of image stabilizer 200 and that of prior art stabilizer configurations. For instance, image stabilizers 200 and 800 may be implemented with components having the same size and functionality, such as magnets, coils, point contactor, lens supporting module, ferromagnetic material, Hall sensors, etc. However, the configuration of image stabilizer 800 results in a thinner design, and thus may be implemented in systems having smaller dimensions and specifications, such as a mobile phone, personal data assistant, wrist watch, etc. For example, image stabilizer may be designed to fit the dimensions of other components for integration with other functionalities. For instance, image stabilizer 800 may be designed to be 12 mm×12 mm, and 2 mm thick. It should be noted, that these dimensions are not intended to be limiting, but instead are exemplary. Embodiments of the present invention contemplate adjusting the size of image stabilizer 800 to meet the specifications or sizes of other components or devices.

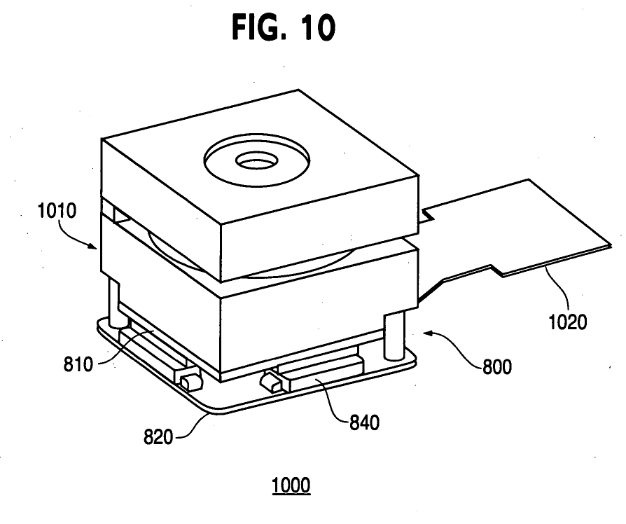

In certain embodiments, the thinner design of image stabilizer 800 may promote the application of additional functionalities. For example, FIG. 10 shows an block diagram of an exemplary image stabilizer and auto focusing combination system 1000 consistent with certain embodiments of the present invention. As shown, image stabilizer 800 may be configured with an auto-focusing module 1010 used in image capture devices. Auto-focusing module 1010 may be a device that operates similar to known auto-focusing components of image capture devices. For instance, in one embodiment, auto-focusing module 1010 may adjust the focusing of an image based on movements of certain components, such as a lens or a components including an aperture for providing light to a lens. To this end, the disclosed embodiments may adjust the position of the lens or other type of components by moving movable base 810 in relation to stationary base 820 in accordance with the features and operations disclosed above. Circuitry and/or processing components may interface with combination system 1000 to control image stabilizer 800 and/or auto-focusing module 1010 to provide multiple operations, such as image focusing and stabilization. For example, a flexible circuit board 1020 may be implemented to support the circuitry and processing components used for controlling combination system 1000 and for receiving data and/or signals from combination system 1000, such as position data, etc.

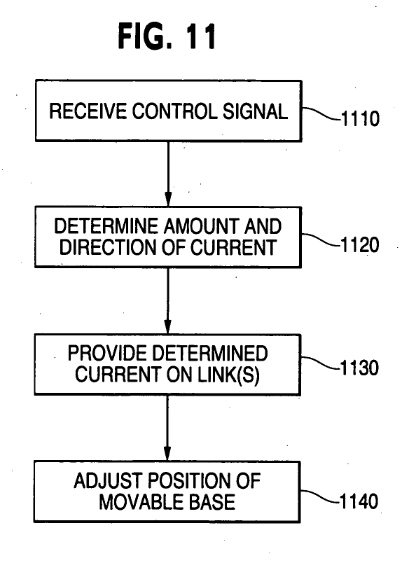

As explained, embodiments of the present invention enable a movable base positioned on top of a stationary base to provide image stabilization and/or auto-focusing operations. FIG. 11 shows a flowchart of an exemplary image stabilization process that may be performed by the disclosed embodiments. A user, for example, may use image capture device 100 to capture an image. When performing an image capture operation, the user may shake device 100 such that images may be blurred when captured. This movement may be detected and measured by movement detection system 105. Based on the measurements, movement detection system 105 may produce signals associated with the amount of movement experienced by device 100 (Step 1110). These signals may be provided to a system, such as a processor or circuit, that determines an amount and direction of current I₁ and/or I₂ that may be used to adjust the position of movable base 210 to compensate for the movement of device 100 (Step 1120). As such, a current source provides the determined amount of current I in the determined direction on the appropriate link(s) 720, 730 (Step 1130). In response, and in accordance with the embodiments disclosed herein, the position of movable base 210, 810 is adjusted along a corresponding axis to correct the affects of the movement of device 100 (Step 1140).

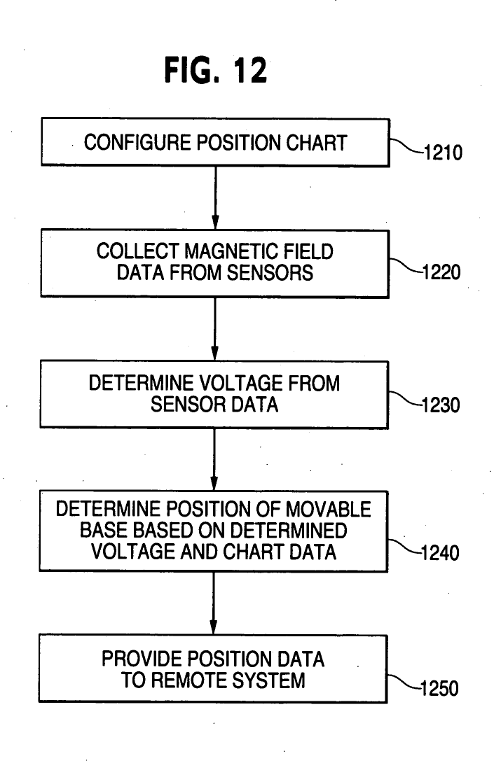

In another embodiment, image stabilizer 200, 800 may be configured to provide position data associated with movable base 210, 810 in relation to stationary base 220, 820. FIG. 12 shows a flowchart of an exemplary position determination process consistent with certain embodiments. Initially, a position chart is configured that records the relationship between movements of movable base 210, 810 and stationary base 220, 820 (Step 1210). For example, a system may be configured to first determine the spatial coordinates of movable base 210, 820 and stationary base 220, 820 at a certain default position, such as a position of these components when no image stabilization operations is performed, such as a center point in relation to movable base 210, 810 and stationary base 220, 820. Through testing, the system may measure the spatial positions of the movable base in relation to the stationary base, based on voltage amounts corresponding to the magnetic fields associated with the magnets corresponding to Hall sensors 540. The position data and voltage amounts are stored in a data structure such that a map is created showing the position of movable base 210, 810, in relation to the stationary base 220, 820, based on the amount of voltage on links 720, 730.

Subsequently, during operation of image stabilizer 200, 800, Hall sensors 540 may collect magnetic field data associated with the movement of movable base 210, 810 (Step 1220). The magnetic field data may be provided to a position determination system connected to image stabilizer 200, 800. The position determination system may be circuitry and/or a processor that executes software to perform methods consistent with certain embodiments of the present invention. The position determination system may be located within image capture device 106 or located remote from device 100 and connected by a communication link. Based on the magnetic field data, the position determination system may determine the voltage corresponding to the magnetic fields produced by the Hall sensor magnets (Step 1230). The position determination system accesses the data structure storing the position chart to determine the position of movable base 210, 810 based on the amount of determined voltage (Step 1240). The position determination system may then generate data reflecting the position, and provide this information to a remote system for subsequent processing (Step 1250). For example, the position determination system may provide the position data to a processing system that produces user interface data that is presented to a user via a computer display device. Alternatively, the position determination system may provide the position data to another processor, circuit, etc. for performing other functions, such as controlling another component of image capture device 100. Use of the position data is not intended to be limited to the above examples.

As described, embodiments of the present invention reduce the amount of power required to perform image stabilization processes by reducing the amount of friction experienced between a point contactor and a lens supporting module. Based on the mass of image stabilizer 200, 800, and/or the mass of movable base 210, 810, the amount of current required to move movable base 210, 810 may be determined. Accordingly, in another embodiment, a processor system may be configured to perform software code that determines the amount of current required to adjust the position of a movable base of mass M, based on other variables, such as the mass of the movable base, the type of material of the ball bearings used in a point contactor, the type of material used in lens supporting module, the type of conductor wire used for the links of the voice coil motor arrangement, etc. The software code may be stored on a computer-readable medium and accessed by a processor in response to a user or machine initiated command or request. The processor system may produce data associated with the results of the determination to assist in design, manufacture, testing, reconfiguring, etc. image stabilizers in accordance with the disclosed embodiments.

It will be apparent to those skilled in the art that various modifications and variations can be made in the disclosed embodiments without departing from the scope of the invention. Other embodiments of the disclosed embodiments will be apparent to those skilled in the art from consideration of the specification and practice of the disclosed embodiment. Although the examples of image stabilizers 200 and 800 are described with reference an image device, it should be noted that methods and systems consistent with the disclosed embodiments may be used with structures and components other than image devices. For example, the various embodiments of the image stabilizer disclosed herein may be implemented in other types of systems, and used to move any type of component connected to a support mechanism, such as a lens supporting module. Also, the type of material used for ball bearings 320 may vary from each ball bearing. That is, point contactor 320 may include ball bearings 320 made of different materials, such as metal, plastic, ceramic, rubber, etc. Additionally, the location of certain components are not limited to the examples disclosed above. For example, the stationary base may include a set of magnets or a set of coils and the movable base may include a corresponding set of coils or a set of magnets that respectively match with the coils or magnets of the movable base. Further, Hall sensors may be be located on either the stationary and movable base with the Hall sensor magnets located on the other respective movable or stationary base. Additionally, an image capture component (e.g., CCD) may be set on the movable base or stationary base. For example, the image capture component (e.g., CCD) may be set on the stationary base and at least one optical element set on the movable base such that when the movable base moves in relation to the stationary base, the image position on the CCD is adjusted. Alternatively, the image capture component (e.g., CCD) may be set on the movable base such that the position of CCD is adjusted to project the image based on certain positions on the CCD.

Further, the process steps shown in FIGS. 11 and 12 may be performed in different order, and are not limited to the sequences illustrated therein. Also, additional or fewer process steps may be implemented during these processes. Further, methods and systems consistent with the disclosed embodiments may allow the embodiments of the image stabilizer disclosed herein to receive signals from any type of control circuit that may execute software to perform certain functions related to aspects of the present invention. Additionally, the embodiments of image stabilizer system disclosed herein may also include components, such as processing components, that are configured to execute software to perform various functions, such as determining position data from signals produced by the embodiments of the image stabilizer described above. Moreover, for example, image capture device 100 may include processing components that execute software to perform operations based on the information provided by image stabilizer system 100. Therefore, embodiments of the present invention may implement and/or interface with one or more processors, processing systems, etc., that including known computing components, such as one or more processors, software, firmware, hardware, that perform one or more processes.

Additionally, the disclosed embodiments may implement one or more software programs stored in memory and other types of storage mediums, such as like hard disks, floppy disks, optical storage devices, DVDs, or CD-ROM; or other forms of RAM or ROM. It is intended that the disclosed embodiments and described examples be considered as exemplary only, with a true scope of the invention being indicated by the following claims and their equivalents.

What is claimed is:

1. A system for providing image stabilization in an image capture device, comprising:
a stationary base included in the image capture device;
a movable base positioned on top of the stationary base; and
a point contactor including a set of ball bearings and configured to be either:
connected to the stationary base such that the set of ball bearings contact a supporting module connected to the movable base such that the movable base moves in relation to the stationary base, or
connected to the movable base such that the set of ball bearings contact a supporting module connected to the stationary base such that the movable base moves in relation to the stationary base.

2. The system of claim 1, wherein the stationary base includes one of a set of coils and a set of magnets and the movable base includes one of a set of magnets and a set of coils, and
when the movable base includes a set of coils and the stationary base includes a set of magnets, and when the movable base is positioned on top of the stationary base, each coil in the set of coils is positioned above a corresponding magnet in the set of magnets included on the stationary base, and
when the movable base includes a set of magnets and the stationary base includes a set of coils, and when the movable base is positioned on top of the stationary base, each magnet in the set of magnets is positioned above a corresponding coil in the set of coils included on the stationary base.

3. The system of claim 2, wherein a first pair of coils in the set of coils are connected to a first link, and a second pair of coils in the set of coils are connected to a second link, and wherein the movable base moves in relation to the stationary base in accordance with current applied to at least one of the first and second links.

4. The system of claim 3, wherein the movable base moves in a first direction based on an amount and direction of first current applied on the first link and moves in a second direction based on an amount and direction of second current applied on the second link.

5. The system of claim 2, wherein the set of coils and the set of magnets are positioned outside of a space underneath and above of the point contactor.

6. The system of claim 1, wherein the image capture device is a mobile phone.

7. The system of claim 2, wherein a first coil is positioned on the movable base and a first magnet is positioned on the stationary base, and the system further includes:
a first ferromagnetic material positioned between the movable base and the first coil and a second ferromagnetic material positioned between the stationary base and the first magnet.

8. The system of claim 2, wherein a first coil is positioned on the stationary base and a first magnet is positioned on the movable base, and the system further includes:
a first ferromagnetic material positioned between the stationary base and the first coil and a second ferromagnetic material positioned between the movable base and the first magnet.

9. The system of claim 1, further including a Hall sensor arrangement including:
a Hall sensor positioned on the stationary base; and
a Hall sensor magnet positioned on the movable base such that it is located above the Hall sensor,
wherein the Hall sensor measure a magnetic field associated with the Hall sensor magnet as the movable base moves in relation to the stationary base.

10. The system of claim 1, further including a Hall sensor arrangement including:
a Hall sensor positioned on the movable base; and
a Hall sensor magnet positioned on the stationary base such that it is located above the Hall sensor,
wherein the Hall sensor measure a magnetic field associated with the Hall sensor magnet as the movable base moves in relation to the stationary base.

11. The system of any one of claims 9 and 10, wherein the system includes a position determination system that receives the measured magnetic field from the Hall sensor to determine a position of the movable base in relation to the stationary base.

12. The system of claim 11, wherein the position determination system determines a voltage associated with the magnetic field and determines the position of the movable base by accessing a data structure stored on a memory device that stores information reflecting a relationship between positions of the movable base in relation to the stationary base and voltages associated with magnetic fields produced by the Hall sensor magnet.

13. The system of claim 1, wherein each ball bearing is configured with one of the following materials:
metal,
plastic,
ceramic, and
rubber.

14. A method for performing image stabilization in an image capture device, comprising:
providing a first amount of current in a first direction on a link connected to a pair of coils positioned on a movable base that is positioned above a stationary base including a pair of magnets, the movable base positioned such that each coil of the pair of coils is positioned above a corresponding magnet of the pair of magnets; and
moving the movable base in a first direction, in relation to the stationary base, based on the first amount and first direction of current on the link such that the movement of the movable base causes a set of ball bearings of a point contactor connected to the stationary base to roll against a supporting module connected to the movable base.

15. The method of claim 14, further comprising:
providing a second amount of current in a second direction on a second link connected to a second pair of coils positioned on the movable base such that each coil of the second pair of coils is positioned above a corresponding magnet of a second pair of magnets on the stationary base; and
moving the movable base in a second direction, in relation to the stationary base, based on the second amount and second direction of current on the second link such that the movement of the movable base causes the set of ball bearings of the point contactor connected to the stationary base to roll against the supporting module connected to the movable base.

16. The method of claim 14, further including:
configuring the pair of coils and the pair of magnets such that they are positioned outside of a space underneath and above of the point contactor.

17. The method of claim 14, wherein the pair of coils includes a first coil positioned on the movable base and the pair of magnets includes a first magnet positioned on the stationary base, and the method further includes:
adjusting a magnetic flux produced by the first magnet through a first ferromagnetic material positioned between the movable base and the first coil and a second ferromagnetic material positioned between the stationary base and the first magnet.

18. The method of claim 14, further including:
measuring a magnetic field associated with a Hall magnet positioned on the movable base that is located above a Hall sensor positioned on the stationary base; and
determining a position of the movable base in relation to the stationary base, based on the measured magnetic field.

19. The method of claim 18, further including:
determining a voltage associated with the measured magnetic field;
accessing a data structure storing data reflecting positions of the movable base in relation to the stationary base and voltages associated with magnetic fields produced by the Hall sensor magnet; and
determining the position of the movable base by comparing the determined voltage to voltages represented in the data structure.

20. The method of claim 14, further including:
determining the first amount of current based on respective masses of the movable and stationary bases.

21. A system for providing image stabilization in an image capture device, comprising:
a first means including a set of magnets and included in the image capture device;
a second means positioned on top of the first means such that the second means moves in relation to the first means to compensate for a movement of the image capture device; and
a third means connected to the first means and including friction reducing means that contact a supporting module connected to the second means.

22. The system of claim 21, wherein the first and second means include respective components that form a voice coil motor when the second means is positioned above the first means, the voice coil motor controlling movement of the second means in relation to the first means.

23. A method for performing image stabilization in an image capture device, comprising:
providing a first amount of current in a first direction on a link connected to a pair of coils positioned on a stationary base that is positioned below a movable base including a pair of magnets, the stationary base positioned such that each coil of the pair of coils is positioned below a corresponding magnet of the pair of magnets; and
moving the movable base in a first direction, in relation to the stationary base, based on the first amount and first direction of current on the link such that the movement of the movable base causes a set of ball bearings of a point contactor to roll against a supporting module.
